(19) United States
(12) Patent Application Publication
(10) Pub. No.: US 2020/0047341 A1
(43) Pub. Date: Feb. 13, 2020

(54) CONTROL METHOD AND DEVICE FOR ROBOT, ROBOT AND CONTROL SYSTEM

(71) Applicants: BEIJING JINGDONG SHANGKE INFORMATION TECHNOLOGY CO., LTD., Beijing (CN); BEIJING JINGDONG CENTURY TRADING CO., LTD., Beijing (CN)

(72) Inventors: Peng SONG, Beijing (CN); Zongjing YU, Beijing (CN); Chao ZHANG, Beijing (CN); Guangsen MOU, Beijing (CN)

(73) Assignees: BEIJING JINGDONG SHANGKE INFORMATION TECHNOLOGY CO., LTD., Beijing (CN); BEIJING JINGDONG CENTURY TRADING CO., LTD., Beijing (CN)

(21) Appl. No.: 16/492,692

(22) PCT Filed: Dec. 29, 2017
(86) PCT No.: PCT/CN2017/119685

§ 371 Date: Sep. 10, 2019

(30) Foreign Application Priority Data
Mar. 22, 2017 (CN) 201710174313.2

(51) Int. Cl. B25J 9/16; G05D 1/02; G10L 15/22

(52) U.S. Cl. CPC B25J 9/1666; B25J 9/1697; G05D 1/0219; G10L 2015/223; G05D 1/0214; G10L 15/22; G05D 1/0225

(57) ABSTRACT

A control method and device for a robot, a robot, and a control system in the field of automatic control. The control device for a robot determines a path for the robot moving to an adjacent area of the bound user by receiving current position information of a bound user sent by a server at a predetermined frequency, wherein the adjacent area of the bound user is determined by a current position of the bound user, and drive the robot to move along a determined path to the adjacent area of the bound user.

### CROSS-REFERENCE TO RELATED APPLICATIONS

The present application is based on and claims priority to CN Patent Application No. 201710174313.2 filed on Mar. 22, 2017, the disclosure of which is incorporated by reference herein in its entirety.

### TECHNICAL FIELD

The present disclosure relates to the field of automatic control, and in particular, to a control method and device for a robot, a robot, and a control system.

### BACKGROUND

At present, most supermarket shopping carts need to occupy both hands of consumers to obtain power for movement, so that a user is unable to operate other than cart during the shopping, for example using mobile phones, selecting commodity, and the like. If it is desired to carry out the above operations, it is possible only when the cart is stopped. Especially for a consumer who carries babies, moves inconveniently or is young and is old, it may be even difficult to move a shopping cart, so that the s shopping experience and efficiency of the consumer may be affected.

### SUMMARY

According to a first aspect of an embodiment of the present disclosure, a control method for a robot is provided. The method comprises: receiving current position information of a bound user sent by a server at a predetermined frequency; determining a first path for the robot moving to an adjacent area of the bound user, wherein the adjacent area of the bound user is determined by a current position of the bound user; driving the robot to move along the path to the adjacent area of the bound user.

In some embodiments, the driving the robot comprises: detecting whether an obstacle appears in front of the robot in a process of driving the robot to move along the path; controlling the robot to pause in a case where the obstacle appears in front of the robot; driving the robot to continue to move along the path in a case where the obstacle disappears within a predetermined time; detecting an ambient environment of the robot in a case where the obstacle does not disappear within a predetermined time; redetermining a second path for the robot moving to the adjacent area of the bound user according to the ambient environment; driving the robot to move along a redetermined path to the adjacent area of the bound user.

In some embodiments, in the adjacent area of the bound user, a distance between the robot and the bound user is greater than a first predetermined distance and less than a second predetermined distance, wherein the first predetermined distance is less than the second predetermined distance.

In some embodiments, receiving playback information sent by an adjacent shelf in the process of driving the robot to move; playing the playback information, so that the bound user knows about commodity information on the adjacent shelf.

In some embodiments, before playing the playback information, further comprising: extracting an identifier of the playback information; determining whether the identifier matches historical data of the bound user; wherein the playback information is played when the identifier matches the historical data of the bound user, and the historical data of the bound user is sent by the server.

In some embodiments, further comprising: collecting a facial image of the bound user; identifying the facial image to obtain facial feature information of the bound user; sending the facial feature information to the server, so that the server queries the historical data of the bound user associated with the facial feature information.

In some embodiments, identifying voice information to obtain a voice instruction of the bound user after collecting the voice information of the bound user; sending the voice instruction to the server, so that the server processes the voice instruction by analyzing; receiving response information from the server; determining a third path for the robot moving to the destination address in a case where the response information includes a destination address; driving the robot to move along a determined path to lead the bound user to the destination address; playing predetermined guidance information when the robot is driven to move along the determined path; playing reply information to interact with the bound user in a case where the response information includes the reply information.

In some embodiments, further comprising: switching a state of the robot to an operating state in a case where the robot receives a trigger instruction sent by the server in an idle state; sending state switch information to the server, so that the server binds the robot to a corresponding user; switching the state of the robot to the idle state after the bound user finishes using the robot; sending state switch information to the server, so that the server releases a binding relationship between the robot and the bound user; after switching the state of the robot to the idle state, determining a fourth path for the robot moving to a predetermined parking place; driving the robot to move along a determined path to the predetermined parking place to achieve automatic homing.

According to a second aspect of the embodiment of the present disclosure, a control device for a robot is provided. The device comprises: a memory configured to store instructions; a processor coupled to the memory, wherein based on the instructions stored in the memory, the processor is configured to: receive current position information of a bound user sent by a server at a predetermined frequency; determine a first path for the robot moving to an adjacent area of the bound user, wherein the adjacent area of the bound user is determined by a current position of the bound user; drive the robot to move along the path to the adjacent area of the bound user.

In some embodiments, the processor is configured to: detect whether an obstacle appears in front of the robot in a process of driving the robot to move along the path; control the robot to pause in a case where the obstacle appears in front of the robot; drive the robot to continue to move along the path in a case where the obstacle disappears within a predetermined time; detect an ambient environment of the robot in a case where the obstacle does not disappear within a predetermined time; redetermine a second path for the robot moving to the adjacent area of the bound user according to the ambient environment; drive the robot to move along a redetermined path to the adjacent area of the bound user.

In some embodiments, in the adjacent area of the bound user, a distance between the robot and the bound user is greater than a first predetermined distance and less than a second predetermined distance, wherein the first predetermined distance is less than the second predetermined distance.

In some embodiments, the processor is configured to: receive playback information sent by an adjacent shelf in the process of driving the robot to move; play the playback information, so that the bound user knows about commodity information on the adjacent shelf.

In some embodiments, the processor is configured to: extract an identifier of the playback information before playing the playback information; determine whether the identifier matches historical data of the bound user; wherein the playback information is played when the identifier matches the historical data of the bound user, and the historical data of the bound user is sent by the server.

In some embodiments, the processor is configured to: collect a facial image of the bound user; identify the facial image to obtain facial feature information of the bound user; send the facial feature information to the server, so that the server queries the historical data of the bound user associated with the facial feature information.

In some embodiments, the processor is configured to: identify voice information to obtain a voice instruction of the bound user after collecting the voice information of the bound user; send the voice instruction to the server, so that the server processes the voice instruction by analyzing; receive response information from the server; determine a third path for the robot moving to the destination address in a case where the response information includes a destination address; drive the robot to move along a determined path to lead the bound user to the destination address; play predetermined guidance information when the robot is driven to move along the determined path; play reply information to interact with the bound user in a case where the response information includes the reply information.

In some embodiments, the processor is configured to: switch a state of the robot to an operating state in a case where the robot receives a trigger instruction sent by the server in an idle state; send state switch information to the server, so that the server binds the robot to a corresponding user; switch the state of the robot to the idle state after the bound user finishes using the robot; send state switch information to the server, so that the server releases a binding relationship between the robot and the bound user; wherein after switching the state of the robot to the idle state, determining a fourth path for the robot moving to a predetermined parking place; drive the robot to move along a determined path to the predetermined parking place to achieve automatic homing.

According to a third aspect of the embodiment of the present disclosure, a robot is provided. The robot comprises the control device for a robot according to any of the aforementioned embodiments.

According to a fourth aspect of the embodiment of the present disclosure, a control system for a robot is provided. The system comprises: the robot according to a fourth aspect of the embodiment of the present disclosure, and a server configured to determine the current position information of the user according to beacon information provided by a user beacon device, and send the current position information of the user to the robot bound to the user at a predetermined frequency.

In some embodiments, the server is further configured to perform at least one of the following operations: querying historical data of the user and send the historical data of the user to a robot bound to the user; querying historical data of a corresponding user according to facial feature information sent by the robot, and send the queried historical data to a corresponding robot, analyzing a voice instruction sent by the robot, and send a corresponding destination address to a corresponding robot if the voice instruction is used to obtain navigation information; sending corresponding reply information to a corresponding robot when the voice instruction is used to obtain a reply to a specified question; sending a trigger instruction to the robot in an idle state to bind the robot to a corresponding user after the robot is switched from the idle state to an operating state; releasing a binding relationship between the robot and the bound user after the robot is switched from the operating state to the idle state.

According to a fifth aspect of the embodiment of the present disclosure, a non-transitory computer readable storage medium is further provided, wherein the computer readable storage medium stores computer instructions that, when executed by a processor, implement the method according to any of the aforementioned embodiments.

Other features and advantages of the present disclosure will become apparent from the following detailed description of exemplary embodiments of the present disclosure with reference to the accompanying drawings.

### BRIEF DESCRIPTION OF THE DRAWINGS

In order to more clearly explain the embodiments of the present disclosure or the technical solutions in the prior art, a brief introduction will be given below for the drawings required to be used in the description of the embodiments or the prior art. It is obvious that, the drawings illustrated as follows are merely some of the embodiments of the present disclosure. For those skilled in the art, they may also acquire other drawings according to such drawings on the premise that no inventive effort is involved.

FIG. 1 is an exemplary flow chart showing a robot control method according to one embodiment of the present disclosure;

FIG. 2 is an exemplary flow chart showing a robot control method according to another embodiment of the present disclosure;

FIG. 3 is an exemplary block diagram showing a control device for a robot according to one embodiment of the present disclosure;

FIG. 4 is an exemplary block diagram showing a control device for a robot according to another embodiment of the present disclosure;

FIG. 5 is an exemplary block diagram showing a control device for a robot according to still another embodiment of the present disclosure;

FIG. 6 is an exemplary block diagram showing a control device for a robot according to still another embodiment of the present disclosure;

FIG. 7 is an exemplary block diagram showing a control device for a robot according to still another embodiment of the present disclosure;

FIG. 8 is an exemplary block diagram showing a control device for a robot according to still another embodiment of the present disclosure;

FIG. 9 is an exemplary block diagram showing a robot according to one embodiment of the present disclosure;

FIG. 10 is an exemplary block diagram showing a robot control system according to one embodiment of the present disclosure.

### DETAILED DESCRIPTION

The technical solution in the embodiments of the present disclosure will be explicitly and completely described in combination with the drawings in the embodiments of the present disclosure. Apparently, the described embodiments are merely part of the embodiments of the present disclosure, rather than all the embodiments. The following descriptions of at least one exemplary embodiment which are in fact merely descriptive, by no means serve as any delimitation on the present disclosure as well as its application or use. On the basis of the embodiments of the present disclosure, all the other embodiments acquired by a person skilled in the art on the premise that no inventive effort is involved fall into the scope protected by the present disclosure.

Unless additionally specified, the relative arrangements, numerical expressions and numerical values of the components and steps expounded in these examples do not limit the scope of the present invention.

At the same time, it should be understood that, in order to facilitate the description, the dimensions of various parts shown in the drawings are not delineated according to actual proportional relations.

The techniques, methods, and apparatuses known to a common technical person in the relevant art may not be discussed in detail, but where appropriate, techniques, methods, and apparatuses should be considered as part of the granted description.

Among all the examples shown and discussed here, any specific value should be construed as being merely illustrative, rather than as a delimitation. Thus, other examples of exemplary embodiments may have different values.

It should be noted that similar reference signs and letters present similar items in the following drawings, and therefore, once an item is defined in a drawing, there is no need for further discussion in the subsequent drawings.

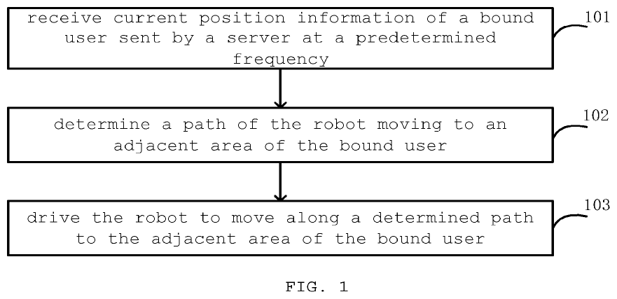

FIG. 1 is an exemplary flow chart showing a robot control method according to one embodiment of the present disclosure. In some embodiments, the method steps of the present embodiment may be performed by a control device for a robot. As shown in FIG. 1, the method comprises:

In step 101, the control device receives current position information of a bound user sent by a server at a predetermined frequency.

In some embodiments, the server may be a business server, a cloud server, or other type of server.

In some embodiments, after the user enters a corresponding place, the user may carry a beacon device which may send beacon information. The server may determine a position of the user according to the beacon information, and send the current position information of the user to the robot bound to the user at a predetermined frequency. Here, the robot may be a smart shopping cart, or other smart movable device that may carry articles.

In some embodiments, the robot may be switched between an operating state and an idle state. The server may select a robot in an idle state to be bound to the user.

In some embodiments, if the robot receives a trigger instruction sent by the server in an idle state, the state of the robot is switched to an operating state, and the state switch information is sent to the server, so that the server binds the robot to a corresponding user.

In step 102, the control device determines a path for the robot moving to an adjacent area of the bound user. The adjacent area of the bound user is determined by a current position of the bound user.

In some embodiments, the map information of a current place may be used, by taking a current position of the robot as a departure point, and an adjacent area of the bound user as a destination, to perform path planning between the departure point and the destination. Since the inventive gist of the present disclosure does not consist in path planning, description will not be made in detail here.

In step 103, the control device drives the robot to move along a determined path to the adjacent area of the bound user.

In some embodiments, in the adjacent area of the bound user, a distance between the robot and the bound user is greater than a first predetermined distance and less than a second predetermined distance. The first predetermined distance is less than the second predetermined distance.

That is, the distance between the robot and the bound user is within a certain range, thereby avoiding that the robot is too far from the user to cause inconvenient use by the user, and the robot is too close to the user, so that the user's walking may be affected.

In the control method for a robot provided by the above-described embodiment, the user is bound to the robot which follows on the bound user's side by automatic movement, so that it is possible to free both hands of the user and significantly improve the user experience.

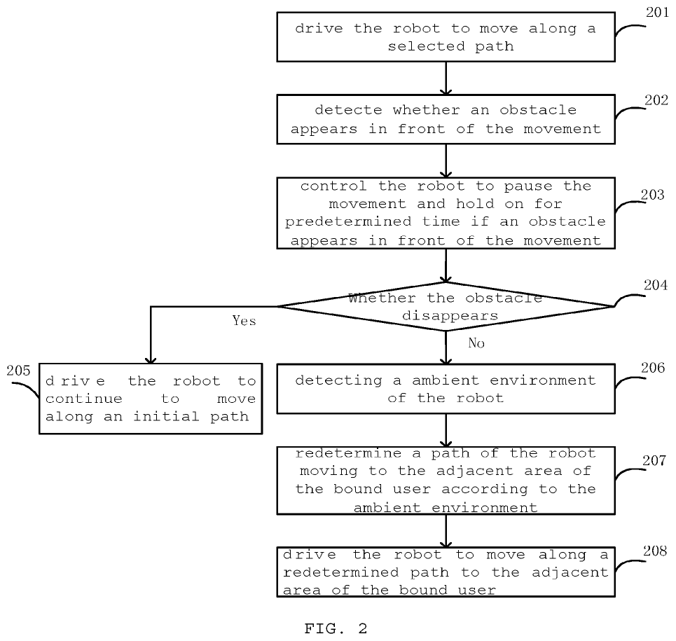

FIG. 2 is an exemplary flow chart showing a robot control method according to another embodiment of the present disclosure.

In some embodiments, the method steps of the present embodiment may be performed by a control device for a robot. In the process of driving the robot to move along a path to an adjacent area of the bound user, if an obstacle appears in front of a movement, automatic handling may also be performed. As shown in FIG. 2, the method comprises:

In step 201, the control device drives the robot to move along a selected path.

In step 202, the control device detects whether an obstacle appears in front of the robot.

In some embodiments, it is possible to collect the video information in front of the robot by a camera and perform analysis.

In step 203, the control device controls the robot to pause and hold on for predetermined time if the obstacle appears in front of the robot.

In step 204, the control device detects whether the obstacle disappears. If the obstacle disappears, step 205 is performed. If the obstacle still does not disappear, step 206 is performed.

In step 205, the control device drives the robot to continue to move along an initial path.

In step 206, the control device detects ambient environment of the robot.

In step 207, the control device redetermines a path for the robot moving to the adjacent area of the bound user according to the ambient environment.

In step 208, the control device drives the robot to move along a redetermined path to the adjacent area of the bound user.

That is, during the movement of the robot, if an obstacle appears ahead, for example, it might be another person or robot, the robot may hold on for a moment. If the obstacle leaves on its own, the robot may continue to move according to a scheduled route. If the obstacle is always present, the robot performs path planning again according to a current position and a target position, and moves according to a re-planned path. This may allow the robot to avoid obstacles automatically when following the bound user.

In some embodiments, playback information sent by an adjacent shelf is received in the process of driving the robot to move, so that the bound user knows about information of commodity on the adjacent shelf.

For example, the shelf may playback information in a wireless broadcast manner, and may also send wireless broadcast information when it is detected that a user approaches.

For example, the shelf may send information such as advertisements, promotions, and the like related to the commodity on the shelf. When the robot is in the vicinity of the shelf, the robot can receives the corresponding information. By playing the information, it is possible to allow the user to know about the information of the commodity on the adjacent shelf.

In some embodiments, in order to improve the user experience, the received broadcast information may also be screened according to the historical data of the user.

In some embodiments, after the wireless broadcast information sent by the adjacent shelf is received, an identifier of the wireless broadcast information is extracted to determine whether the identifier matches the historical data of the bound user, and if the identifier matches the historical data of the bound user, the wireless broadcast information is played.

For example, the historical data of the user indicates that the user is interested in electronic products. Therefore, by querying the identifier of the wireless broadcast information, if the information relates to electronic product information, it will be played to the binding user. If the information relates to a discount promotion of a toothbrush, it will not be played to the bound user, thereby improving the user experience.

In some embodiments, the historical data of the bound user involved here is delivered by the server. For example, when the user picks up a beacon device, the server sends the corresponding historical data of the user to the bound robot. As another example, the control device for a robot may collect a facial image of the bound user, and identify the facial image to obtain the facial image information of the bound user, and send the facial feature information to the server, so that the server queries and delivers the historical data of the user associated with the facial feature information. The control device takes the historical data of the user delivered by the server as the historical data of the bound user.

In some embodiments, the robot may also provide navigation service to the bound user. For example, the user may issue a voice instruction to the robot. After collecting the voice information of the bound user, the control device for a robot identifies the voice information to obtain a voice instruction of the bound user, and sends the voice instruction to the server, so that the server analyzes and processes the voice instruction, and sends a corresponding processing result as response information to the control device for a robot. If the response information includes a destination address, the control device for a robot performs path planning to determine a path for the robot moving from a current location to the destination address, and drives the robot to move along a determined path to lead the bound user to the destination address.

For example, if the user says “seafood”, the control device for a robot may determine the position of the seafood area by interacting with the server, and further perform path planning and drive the robot to move accordingly to lead the bound user to the seafood area. In addition, if the user says “check please” or “bill please”, the control device for a robot may drive the robot to lead the bound user to the cashier. With navigation services provided for users, it is possible to perform path planning according to the user's needs, and lead the user to the destination, thereby effectively saving time.

In some embodiments, the control device may also play predetermined guidance information when the robot is driven to move along the determined path.

For example, when the bound user is led to a destination, the guidance information such as “Please follow me” may be played.

In some embodiments, the robot may also interact with the bound user to provide communication services for the bound user. For example, the user may issue a voice instruction to the robot. After collecting the voice information of the bound user, the control device for a robot identifies the voice information to obtain a voice instruction of the bound user, and sends the voice instruction to the server, so that the server analyzes and processes the voice instruction, and sends a corresponding processing result as response information to the control device for a robot. The reply information is played to interact with the bound user if the response information includes reply information.

For example, if the user inquires the price details of a certain commodity, the control device for a robot provides information such as the main manufacturer, features and price of the commodity to the user by interacting with the server, thereby improving the user's shopping pleasure and convenience. At the same time, it is also possible to become a window for manufacturers and brand makers to perform commodity advertising and release promotional information. By answering questions related to the supermarket, commodity, and promotions or other questioned raised by users, the robot can improve the user's shopping pleasure and ensuring that the user can obtain necessary information. At the same time, it is also possible to become a window for manufacturers and brand makes to perform product advertising and release promotional information.

In some embodiments, after the bound user finishes using the robot, the control device switches a state of the robot to an idle state, and sends the state switch information to the server, so that the server releases a binding relationship between the robot and the bound user.

For example, the user may click a corresponding button after finishing the use or pay the bill, so as to switch the state of the robot to an idle state.

In some embodiments, after the state of the robot is switched to an idle state, it is also possible to determine a path for the robot moving to a predetermined parking place by performing path planning, and further drive the robot to move along a determined path to the predetermined parking place to achieve automatic homing.

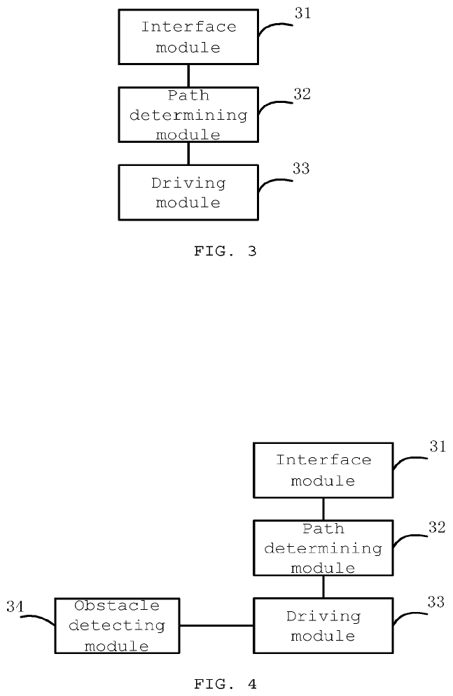

FIG. 3 is an exemplary block diagram showing a control device for a robot according to one embodiment of the present disclosure.

As shown in FIG. 3, the control device for a robot may comprise an interface module 31, a path determining module 32 and a driving module 33.

The interface module 31 is used to receive current position information of a bound user sent by a server at a predetermined frequency.

The path determining module 32 is used to determine a path for the robot moving to an adjacent area of the bound user. The adjacent area of the bound user is determined by a current position of the bound user.

The driving module 33 is used to drive the robot to move along the path to the adjacent area of the bound user.

In some embodiments, in the adjacent area of the bound user, a distance between the robot and the bound user is greater than a first predetermined distance and less than a second predetermined distance, wherein the first predetermined distance is less than the second predetermined distance. Such configuration considers that it may be inconvenient if the robot is too far from the user, and it may affect the user's walking if the robot is too close to the user.

In the control device for a robot provided by the above-described embodiment, the user is bound to the robot which follows on the bound user's side by automatic movement, so that it is possible to free both hands of the user and significantly improve the user experience.

FIG. 4 is an exemplary block diagram showing a control device for a robot according to another embodiment of the present disclosure.

Compared with the embodiment shown in FIG. 3, in the embodiment shown in FIG. 4, the control device for a robot further comprises an obstacle detecting module 34.

The obstacle detecting module 34 is used to detect whether an obstacle appears in front of the robot in a process of the driving module 33 driving the robot to move along the path, such as to instruct the driving module to control the robot to pause if an obstacle appears in front of the robot, and detect whether the obstacle disappears after predetermined time, and instruct the driving module 33 to drive the robot to continue to move along the path if the obstacle disappears.

In some embodiments, the obstacle detecting module 34 is further used to detect ambient environment of the robot in a case where the obstacle still does not disappear. The path determining module 32 is further used to redetermine a path for the robot moving to the adjacent area of the bound user according to the ambient environment. The driving module 33 is further used to drive the robot to move along a redetermined path to the adjacent area of the bound user.

Thus, in a case where an obstacle appears in front of the robot, automatic roundabout may be realized according to the current environment.

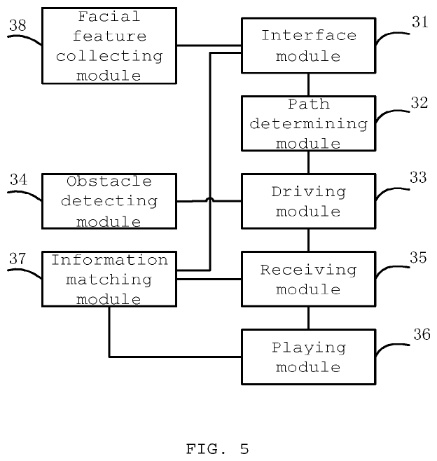

FIG. 5 is an exemplary block diagram showing a control device for a robot according to still another embodiment of the present disclosure.

Compared with the embodiment shown in FIG. 4, in FIG. 5, the control device for a robot further comprises a receiving module 35 and a playing module 36.

The receiving module 35 is used to receive the wireless broadcast information sent by an adjacent shelf in the process of the driving module 33 driving the robot to move.

The playing module 36 is used to play the wireless broadcast information, so that the bound user knows about information of the commodity on the adjacent shelf.

Accordingly, it is possible to facilitate knowing about information such as advertisements, promotions, and the like of the commodity on the adjacent shelf.

In some embodiments, in the embodiment shown in FIG. 5, the control device for a robot may further comprise an information matching module 37 for extracting an identifier of the wireless broadcast information to determine whether the identifier matches the historical data of the bound user after the wireless broadcast information sent by the adjacent shelf is received, and instructing the playing module 36 to play the wireless broadcast information if the identifier matches the historical data of the bound user.

That is, it is possible to only play the information of the user's interest according to the historical data of the user. For example, according to the historical data, the user is interested in electronic products. Therefore, only the related information of electronic products is played, instead of playing the promotional advertisement of a toothbrush to the user, so as to improve the user experience.

In some embodiments, the historical data of the bound user is delivered by the server. The server may provide the corresponding historical data of the user to the bound robot when the user picks up a beacon device. In some embodiments, the server may also deliver corresponding historical data of the user according to the facial features of the user uploaded by the robot.

In some embodiments, as shown in FIG. 5, the control device for a robot may further comprise a facial feature collecting module 38. The facial feature collecting module 38 is used to connect a facial image of the bound user, and identify the facial image to obtain facial feature information of the bound user. The interface module 31 is further used to send the facial feature information to the server so that the server queries historical data of a user associated with the facial feature information, and is further used to receive the historical data of the user delivered by the server as the historical data of the bound user.

Thus, the user may obtain personalized services by scanning the face.

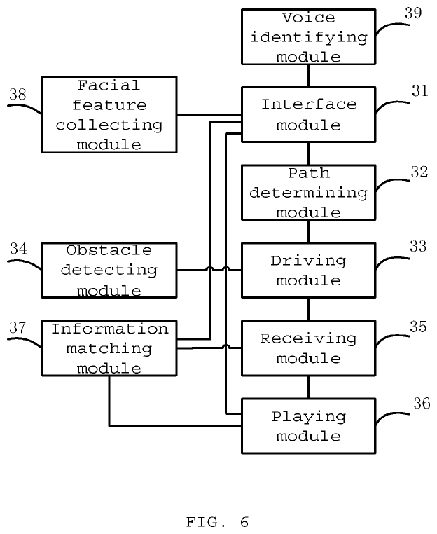

FIG. 6 is an exemplary block diagram showing a control device for a robot according to still another embodiment of the present disclosure.

Compared with the embodiment shown in FIG. 5, in the embodiment shown in FIG. 6, the control device for a robot further comprises a voice identifying module 39.

The voice identifying module 39 is used to identify the voice information to obtain a voice instruction of the bound user after collecting voice information of the bound user.

The interface module 31 is further used to send the voice instruction to the server, so that the server processes the voice instruction by analyzing, and instruct the path determining module 32 to determine a path for the robot moving to a destination address if the response information includes a destination address after the response information from the server is received.

The driving module 33 is further used to drive the robot to move along a determined path so as to lead the bound user to the destination address.

Therefore, the user may obtain navigation service by issuing a voice instruction. For example, if the user says “seafood”, the control device for a device will drive the robot to move to a seafood area, so as to lead the way for the user.

In some embodiments, the playing module 36 is further used to play predetermined guidance information when the driving module 33 drives the robot to move along the determined path.

For example, in the leading process, the guidance information such as “Please follow me” may be played.

In some embodiments, the control device for a robot may also implement interaction between the user and the robot. For example, the interface module 31 is further used to instruct the playing module 36 to play the reply information to interact with the bound user if the response information includes reply information.

FIG. 7 is an exemplary block diagram showing a control device for a robot according to still another embodiment of the present disclosure.

Compared with the embodiment shown in FIG. 6, in FIG. 7, the control device for a robot further comprises a state switch module 310.

The state switch module 310 is used to switch a state of the robot to an operating state when the interface module 31 receives a trigger instruction sent by the server when the robot is in an idle state. The interface module 31 is further used to send state switch information to the server so that the server binds the robot to a corresponding user.

In some embodiments, the state switch module 310 is further used to switch a state of the robot to an idle state after the bound user finishes a use. The interface module 31 is further used to send state switch information to the server, so that the server releases a binding relationship between the robot and the bound user.

In some embodiments, the path determining module 32 is further used to determine a path for the robot moving to a predetermined parking place after the state switch module 310 switches a state of the robot to an idle state. The driving module 33 is further used to drive the robot to move along a determined path to the predetermined parking place to achieve automatic homing.

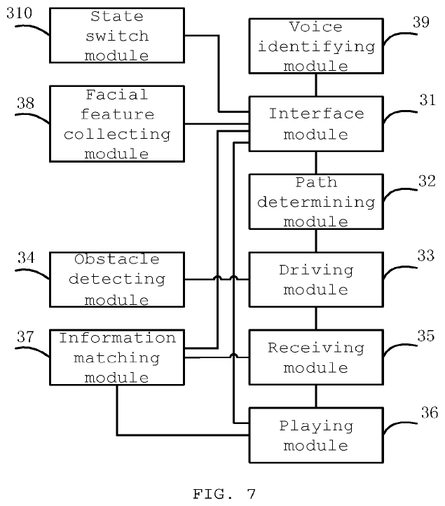

FIG. 8 is an exemplary block diagram showing a control device for a robot according to still another embodiment of the present disclosure.

As shown in FIG. 8, the control device for a robot comprises a memory 801 and a processor 802.

The memory 801 is used to store instructions, and the processor 802 is coupled to the memory 801, wherein the processor 802 is configured to perform and implement the method to which any embodiment in FIGS. 1 to 2.

As shown in FIG. 8, the control device for a robot further comprises a communication interface 803 for performing information interaction with other devices. At the same time, the device further comprises a bus 804, and the processor 802, the communication interface 803, and the memory 801 complete communication with each other via the bus 804.

The memory 801 may contain a high speed RAM (Random-Access Memory) memory, and may also include a non-volatile memory such as at least one disk memory. The memory 801 may also be a memory array. The memory 801 might also be partitioned into blocks which may be combined into a virtual volume according to certain rules.

In some embodiments, the processor 802 may be a central processing unit CPU, or may be an Application Specific Integrated Circuit (ASIC), or one or more integrated circuits configured to implement the embodiments of the present disclosure.

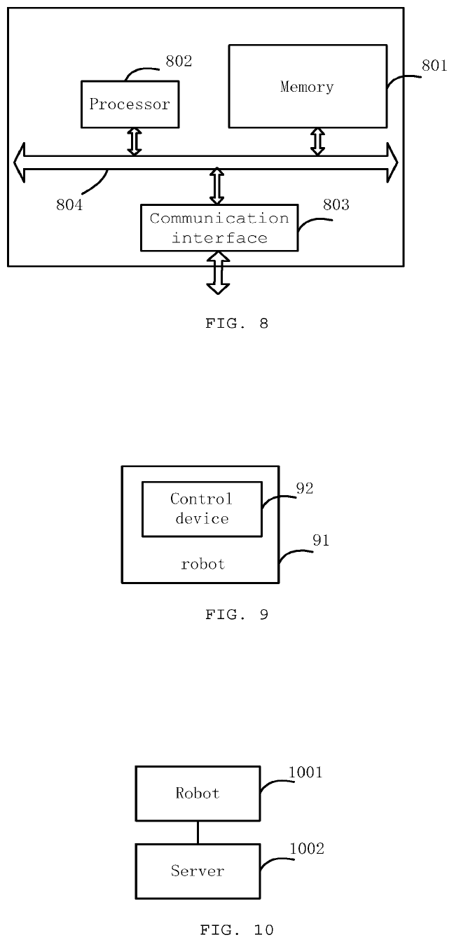

FIG. 9 is an exemplary block diagram showing a robot according to one embodiment of the present disclosure.

As shown in FIG. 9, the robot 91 includes a robot control device 92. In some embodiments, the robot control device 92 may be the robot control device according to any of the embodiments in FIGS. 3 to 8.

FIG. 10 is an exemplary block diagram showing a robot control system according to one embodiment of the present disclosure. As shown in FIG. 10, the system includes a robot 1001 and a server 1002.

The server 1002 is used to determine current position information of the user according to beacon information provided by a user beacon device, and send the current position information of the user to the robot 1001 bound to the user at a predetermined frequency.

In the control system for a robot provided by the above-described embodiment, the user is bound to the robot which follows on the bound user's side by automatic movement, so that it is possible to free both hands of the user and significantly improve the user experience.

In some embodiments, the server 1002 is further used to query historical data of the user and send the historical data of the user to a robot 1001 bound to the user.

Or, the server 1002 may be further used to query historical data of a corresponding user according to the facial feature information sent by the robot 1001, and send the queried historical data to a corresponding robot 1001.

Thus, the robot 1001 may provide a personalized service to the bound user according to the historical data of the user.

In some embodiments, the server 1002 is further used to analyze a voice instruction sent by the robot 1001, and send a corresponding destination address to a corresponding robot 1001 if the voice instruction is used to obtain navigation information. Thereby, the robot 1001 provides navigation service to the bound user.

In some embodiments, the server 1002 is further used to send corresponding reply information to a corresponding robot 1001 when the voice instruction is used to obtain a reply to a specified question. Thereby, the robot 1001 provides information interaction service to the bound user, so that it is possible to improve the user's shopping pleasure and ensure that the user obtains necessary information, and at the same time it is also possible to become a window for manufacturers and brand makers to perform commodity advertising and release promotional information.

In some embodiments, the server 1002 is further used to send a trigger instruction to the robot 1001 in an idle state so as to bind the robot to a corresponding user after the robot is switched from the idle state to an operating state.

In some embodiments, the server 1002 is further used to release a binding relationship between the robot 1001 and the bound user after the robot 1001 is switched from the operating state to the idle state.

In the above-described manner, it is possible to facilitate managing the robot by the server.

In some embodiments, the functional unit modules described in the above-described embodiments may be implemented as a general purpose processor, a programmable logic controller (referred to as PLC for short), a digital signal processor (referred to as DSP for short), an application specific integrated circuit (referred to as ASIC for short), a field-programmable gate array (referred to as FPGA for short) or other programmable logic devices, discrete gates or transistor logic devices, discrete hardware assemblies or any proper combination thereof.

The present disclosure further provides a computer readable storage medium, wherein the computer readable storage medium stores computer instructions that, when executed by a processor, implement the method to which any embodiment in FIG. 1 or 2 relates. Those skilled in the art will appreciate that the embodiments of the present disclosure may be provided as a method, device, or computer program product. Accordingly, the present disclosure may take the form of an entirely hardware embodiment, an entirely software embodiment, or a combination of software and hardware aspects. Moreover, the present disclosure may take the form of a computer program product embodied in one or more computer-usable non-transitory storage media (including but not limited to disk memory, CD-ROM, optical memory, and the like) containing computer usable program codes therein.

Those skilled in the art will appreciate that the embodiments of the present disclosure may be provided as a method, system, or computer program product. Accordingly, the present disclosure may take the form of an entirely hardware embodiment, an entirely software embodiment, or a combination of software and hardware aspects. Moreover, the present disclosure may take the form of a computer program product embodied in one or more computer-usable non-transitory storage media (including but not limited to disk memory, CD-ROM, optical memory, and the like) containing computer usable program codes therein.

The present disclosure is described with reference to the flow charts and/or block diagrams of methods, devices (systems), and computer program products according to the embodiments of the present disclosure. It will be understood that each step and/or block of the flow charts and/or block diagrams as well as a combination of steps and/or blocks of the flow charts and/or block diagrams may be implemented by a computer program instruction. These computer program instructions may be provided to a processor of a general purpose computer, special purpose computer, an embedded processing machine, or other programmable data processing devices to produce a machine, such that the instructions executed by a processor of a computer or other programmable data processing devices produce a device for realizing a function designated in one or more steps of a flow chart and/or one or more blocks in a block diagram.

These computer program instructions may also be stored in a computer readable memory that can guide a computer or other programmable data processing device to operate in a particular manner, such that the instructions stored in the computer readable memory produce a manufacture including an instruction device. The instruction device realizes a function designated in one or more steps in a flow chart or one or more blocks in a block diagram.

These computer program instructions may also be loaded onto a computer or other programmable data processing devices, such that a series of operational steps are performed on a computer or other programmable device to produce a computer-implemented processing, such that the instructions executed on a computer or other programmable devices provide steps for realizing a function designated in one or more steps of the flow chart and/or one or more blocks in the block diagram.

Descriptions of the present disclosure, which are made for purpose of illustration and depiction, are not absent with neglections or limit the present disclosure to the disclosed forms. Many modifications and variations are apparent for those skilled in the art. The embodiments are selected and described in order to better explain the principles and actual application of the present disclosure, and enable those skilled in the art to understand the present disclosure so as to design various embodiments adapted to particular purposes and including various modifications.

1-38. (canceled)

39. A control method for a robot, comprising:
receiving current position information of a bound user sent by a server at a predetermined frequency;
determining a first path for the robot moving to an adjacent area of the bound user, wherein the adjacent area of the bound user is determined by a current position of the bound user;
driving the robot to move along the path to the adjacent area of the bound user.

40. The control method according to claim 39, wherein the driving the robot comprises:
detecting whether an obstacle appears in front of the robot in a process of driving the robot to move along the path;
controlling the robot to pause in a case where the obstacle appears in front of the robot;
driving the robot to continue to move along the path in a case where the obstacle disappears within a predetermined time;
detecting an ambient environment of the robot in a case where the obstacle does not disappear within a predetermined time;
redetermining a second path for the robot moving to the adjacent area of the bound user according to the ambient environment;
driving the robot to move along a redetermined path to the adjacent area of the bound user.

41. The control method according to claim 39, wherein
in the adjacent area of the bound user, a distance between the robot and the bound user is greater than a first predetermined distance and less than a second predetermined distance, wherein the first predetermined distance is less than the second predetermined distance.

42. The control method according to claim 39, further comprising:
receiving playback information sent by an adjacent shelf in the process of driving the robot to move;
playing the playback information, so that the bound user knows about commodity information on the adjacent shelf.

43. The control method according to claim 42, further comprising, before playing the playback information:
extracting an identifier of the playback information;
determining whether the identifier matches historical data of the bound user;
wherein the playback information is played when the identifier matches the historical data of the bound user, and the historical data of the bound user is sent by the server.

44. The control method according to claim 43, further comprising:
collecting a facial image of the bound user;
identifying the facial image to obtain facial feature information of the bound user;
sending the facial feature information to the server, so that the server queries the historical data of the bound user associated with the facial feature information.

45. The control method according to claim 39, further comprising:
identifying voice information to obtain a voice instruction of the bound user after collecting the voice information of the bound user;
sending the voice instruction to the server, so that the server processes the voice instruction by analyzing;
receiving response information from the server;
determining a third path for the robot moving to the destination address in a case where the response information includes a destination address;
driving the robot to move along a determined path to lead the bound user to the destination address;
playing predetermined guidance information when the robot is driven to move along the determined path;
playing reply information to interact with the bound user in a case where the response information includes the reply information.

46. The control method according to claim 39, further comprising:
switching a state of the robot to an operating state in a case where the robot receives a trigger instruction sent by the server in an idle state;
sending state switch information to the server, so that the server binds the robot to a corresponding user;
switching the state of the robot to the idle state after the bound user finishes using the robot;
sending state switch information to the server, so that the server releases a binding relationship between the robot and the bound user;
wherein after switching the state of the robot to the idle state, determining a fourth path for the robot moving to a predetermined parking place;
driving the robot to move along a determined path to the predetermined parking place to achieve automatic homing.

47. A control device for a robot, comprising:
a memory configured to store instructions;
a processor coupled to the memory, wherein based on the instructions stored in the memory, the processor is configured to:
receive current position information of a bound user sent by a server at a predetermined frequency;
determine a first path for the robot moving to an adjacent area of the bound user, wherein the adjacent area of the bound user is determined by a current position of the bound user;
drive the robot to move along the path to the adjacent area of the bound user.

48. A robot, comprising the control device for a robot according to claim 47.

49. A control system for a robot, comprising:
the robot according to claim 48; and
a server configured to determine the current position information of the user according to beacon information provided by a user beacon device, and send the current position information of the user to the robot bound to the user at a predetermined frequency.

50. The control system according to claim 49, wherein
the server is further configured to perform at least one of the following operations:
querying historical data of the user and send the historical data of the user to a robot bound to the user;
querying historical data of a corresponding user according to facial feature information sent by the robot, and send the queried historical data to a corresponding robot;
analyzing a voice instruction sent by the robot, and send a corresponding destination address to a corresponding robot if the voice instruction is used to obtain navigation information;
sending corresponding reply information to a corresponding robot when the voice instruction is used to obtain a reply to a specified question;
sending a trigger instruction to the robot in an idle state to bind the robot to a corresponding user after the robot is switched from the idle state to an operating state;
releasing a binding relationship between the robot and the bound user after the robot is switched from the operating state to the idle state.

51. A non-transitory computer readable storage medium, wherein the computer readable storage medium stores computer instructions, which, when executed by a processor on a computing device, cause the computing device to:
receive current position information of a bound user sent by a server at a predetermined frequency;
determine a first path for the robot moving to an adjacent area of the bound user, wherein the adjacent area of the bound user is determined by a current position of the bound user;
drive the robot to move along the path to the adjacent area of the bound user.

52. The control device according to claim 47, wherein the processor is configured to:
detect whether an obstacle appears in front of the robot in a process of driving the robot to move along the path;
control the robot to pause in a case where the obstacle appears in front of the robot;
drive the robot to continue to move along the path in a case where the obstacle disappears within a predetermined time;
detect an ambient environment of the robot in a case where the obstacle does not disappear within a predetermined time;
redetermine a second path for the robot moving to the adjacent area of the bound user according to the ambient environment;
drive the robot to move along a redetermined path to the adjacent area of the bound user.

53. The control device according to claim 47, wherein
in the adjacent area of the bound user, a distance between the robot and the bound user is greater than a first predetermined distance and less than a second predetermined distance, wherein the first predetermined distance is less than the second predetermined distance.

54. The control device according to claim 47, wherein the processor is configured to:
receive playback information sent by an adjacent shelf in the process of driving the robot to move;
play the playback information, so that the bound user knows about commodity information on the adjacent shelf.

55. The control device according to claim 47, wherein the processor is configured to:
extract an identifier of the playback information before playing the playback information;
determine whether the identifier matches historical data of the bound user;
wherein the playback information is played when the identifier matches the historical data of the bound user, and the historical data of the bound user is sent by the server.

56. The control device according to claim 55, wherein the processor is configured to:
collect a facial image of the bound user;
identify the facial image to obtain facial feature information of the bound user;
send the facial feature information to the server, so that the server queries the historical data of the bound user associated with the facial feature information.

57. The control device according to claim 47, wherein the processor is configured to:
identify voice information to obtain a voice instruction of the bound user after collecting the voice information of the bound user;
send the voice instruction to the server, so that the server processes the voice instruction by analyzing;
receive response information from the server;
determine a third path for the robot moving to the destination address in a case where the response information includes a destination address;
drive the robot to move along a determined path to lead the bound user to the destination address;
play predetermined guidance information when the robot is driven to move along the determined path;
play reply information to interact with the bound user in a case where the response information includes the reply information.

58. The control device according to claim 47, wherein the processor is configured to:
switch a state of the robot to an operating state in a case where the robot receives a trigger instruction sent by the server in an idle state;
send state switch information to the server, so that the server binds the robot to a corresponding user;
switch the state of the robot to the idle state after the bound user finishes using the robot;
send state switch information to the server, so that the server releases a binding relationship between the robot and the bound user;
after switching the state of the robot to the idle state, determining a fourth path for the robot moving to a predetermined parking place;
drive the robot to move along a determined path to the predetermined parking place to achieve automatic homing.
